(19) United States
(12) Patent Application Publication
(10) Pub. No.: US 2023/0339746 A1
(43) Pub. Date: Oct. 26, 2023

(54) APPARATUS COMPRISING A REACTOR FOR DEHYDROGENATING A HYDROGEN-ENRICHED LIQUID HYDROGEN CARRIER

(71) Applicant: Michael Stusch, Nottwil (CH)

(72) Inventors: Michael Stusch, Nottwil (CH); Dirk Zademack, Greifswald (DE)

(21) Appl. No.: 17/800,991

(22) PCT Filed: Feb. 20, 2020
(86) PCT No.: PCT/EP2020/054468

§ 371 Date: Mar. 3, 2023

(51) Int. Cl. B01J 19/24; C01B 3/00

(52) U.S. Cl. CPC C01B 3/0015; B01J 19/249; B01J 2219/2453; B01J 2219/2475; B01J 2219/2479

(57) ABSTRACT

What is described is an apparatus comprising a reactor for dehydrogenating a hydrogen-enriched liquid hydrogen carrier, wherein the reactor comprises at least one hydrogen carrier inlet for the entry of the hydrogen-enriched liquid hydrogen carrier, at least one reactor chamber for at least partial separation of gaseous hydrogen from the hydrogen carrier and for conversion of the hydrogen carrier into an at least partially dehydrogenated state, at least one hydrogen carrier outlet for release of the hydrogen carrier in an at least partially dehydrogenated state, at least one hydrogen outlet for release of the hydrogen separated from the hydrogen carrier, at least one first plate-shaped element and at least one second plate-shaped element, wherein at least one section of the at least one reactor chamber is disposed between the first plate-shaped element and the second plate-shaped element. The invention has this special feature that the at least one first plate-shaped element includes at least one arrangement of a first section and of a second section spaced apart from the first section in a direction transverse to a plane substantially defined by the first plate-shaped element, and the first section of the first plate-shaped element is joined with sealing to the at least one second plate-shaped element so that a first section of the reaction chamber is formed between the second section of the first plate-shaped element and the second plate-shaped element.

The invention relates to an apparatus comprising a reactor for dehydrogenating a hydrogen-enriched liquid hydrogen carrier, wherein the reactor comprises at least one hydrogen carrier inlet for the entry of the hydrogen-enriched liquid hydrogen carrier, at least one reactor chamber for at least partial separation gaseous hydrogen from the hydrogen carrier and for conversion the hydrogen carrier into an at least partially dehydrogenated state, at least one hydrogen carrier outlet for release of the hydrogen carrier which is in an at least partially dehydrogenated state, at least one hydrogen outlet for release of the hydrogen separated from the hydrogen carrier, at least one first plate-shaped element and at least one second plate-shaped element, wherein at least one section of the at least one reactor chamber is disposed between the first plate-shaped element and the second plate-shaped element.

In the prior art it is known to use liquid hydrogen carriers such as, for example, dibenzyltoluene for the transport of hydrogen. Dehydrogenation is required to separate the hydrogen from the liquid hydrogen carrier. For this purpose, an apparatus of the type mentioned above is used, as is known from DE 10 2016 121 688 A1, for example. Such an apparatus comprises a reactor. A hydrogen-enriched liquid hydrogen carrier is fed into the reactor through a hydrogen carrier inlet, in the reactor chamber of which gaseous hydrogen is separated from the hydrogen carrier using a chemical-physical process, thereby converting the hydrogen carrier into an at least partially dehydrogenated state. The hydrogen carrier, which is then at least partially dehydrogenated, is then discharged via a hydrogen carrier outlet, in order then, for example, to be hydrogenated again with hydrogen using a chemical-physical process. The reactor is made up of several plate-shaped elements between which at least one section of the reactor chamber is formed, the plate-shaped elements being provided as partition walls spaced apart from one another in order to partition one section of the reactor chamber from another section of the reactor chamber.

It is an object of the present invention to propose an easy-to-manufacture construction for an apparatus of the type mentioned above.

This object is achieved with an apparatus comprising a reactor for dehydrogenating a hydrogen-enriched liquid hydrogen carrier, wherein the reactor comprises at least one hydrogen carrier inlet for the entry of the hydrogen-enriched liquid hydrogen carrier, at least one reactor chamber for at least partial separation gaseous hydrogen from the hydrogen carrier and for conversion the hydrogen carrier into an at least partially dehydrogenated state, at least one hydrogen carrier outlet for release of the hydrogen carrier which is in an at least partially dehydrogenated state, at least one hydrogen outlet for release of the hydrogen separated from the hydrogen carrier, at least one first plate-shaped element and at least one second plate-shaped element, wherein at least one section of the at least one reactor chamber is disposed between the first plate-shaped element and the second plate-shaped element, characterized in that the at least one first plate-shaped element includes at least one arrangement of a first section and of a second section spaced apart from the first section in a direction transverse to a plane substantially defined by the first plate-shaped element, and the first section of the first plate-shaped element is joined with sealing to the at least one second plate-shaped element so that a first section of the reaction chamber is formed between the second section of the first plate-shaped element and the second plate-shaped element.

First of all, it should be made clear in this context that the first plate-shaped element is a plate-shaped element of a first type and the second plate-shaped element is a plate-shaped element of a second type.

Accordingly, at least one first plate-shaped element is used to construct the reactor, which at least in sections has at least one arrangement of a first section and a second section, wherein, due to the arrangement of a first section and of a second section offset to one another in a direction transverse to a plane substantially defined by the first plate-shaped element, the first section is designed to project or be raised relative to the second section and the second section is designed to project or be raised relative to the first section. In this connection it should be noted that the plane substantially defined by the plate-shaped element is understood to mean a virtual main plane which is substantially defined by the longitudinal and transverse extension of the plate-shaped element. According to the invention, this gives the at least one first plate-shaped element a special structure with at least one elevation that protrudes or rises from a first section of the plate-shaped element in the manner of a “hill” and thus forms a protruding or raised second section that at least partially encloses at least one section of the reactor chamber. At the same time, the reactor chamber section is formed at least partially by a cavity that is partially enclosed by the second section and is thus formed on the inside of the raised second section that faces the first section. This protruding or raised second section is delimited at least in sections by at least one edge, which in turn is at least part of the first section of the plate-shaped element, so that the first section forms a kind of “valley”. Along this at least one edge, the first plate-shaped element is joined with sealing to the second plate-shaped element, which thus delimits the reactor chamber section at least partially enclosed by the protruding or raised second section on the opposite side. By the sealing or sealed connection between the first plate-shaped element and the second plate-shaped element in the area of the first section of the first plate-shaped element, a closed section of the reactor chamber is formed in this manner at least in the area of the at least one edge delimiting the second section between the second section of the first plate-shaped element and the second plate-shaped element. Conversely, since the first section can also be viewed as projecting or raised relative to the second section, alternatively or additionally, at least one reactor chamber section can be formed at least partially by a cavity that is partially enclosed by the first section, and thus on the inside of the first section protruding or raised relative to the second section facing the second section; thus, in principle, the roles of the first section and the second section can also be interchanged.

For the construction of the reactor according to the present invention, only two different components are required, the first plate-shaped element and the second plate-shaped element. By forming at least one second section arranged offset at a distance from the first section in a direction transverse to the plane of the first plate-shaped element, with a small thickness of the first plate-shaped element, high rigidity and load-bearing capacity is achieved in the area of the arrangement of the first section and the second section formed in the first plate-shaped element. This leads to a compact and lightweight design with a relatively high power density. When the plate-shaped elements are made of metal, the material thickness can be selected to be particularly thin, and a particularly low weight can be achieved, particularly when titanium is used. Another advantage of the construction according to the invention is the low production cost, especially when the incorporation of the at least one raised second section in the at least one first plate-shaped element takes place by means of mechanical forming. Furthermore, the construction according to the invention also allows for easy production, for example with the help of robots, which can further reduce the manufacturing costs. In addition, intelligent media routing can be implemented with little effort by skillful forming. Finally, the construction according to the invention allows the best possible heat compression in the smallest space.

Finally, it should also be noted that, using the construction according to the invention, reactor chamber sections can be formed in any desired orientation, such as in particular in a substantially horizontal orientation and in a substantially vertical orientation.

Preferred embodiments and developments of the invention are specified in the dependent claims.

Preferably, at least one first section of the at least one reactor chamber has at least one first channel for passing through the hydrogen-enriched liquid hydrogen carrier, wherein the at least one first channel can preferably be provided for dehydrogenating the hydrogen carrier.

A further preferred embodiment is characterized in that several first plate-shaped elements and several second plate-shaped elements are arranged adjacent to one another in an alternating order, so that in each case an element adjacent to a first plate-shaped element is a second plate-shaped element and the first and second plate-shaped elements are therefore alternating in sequence. In this way, a stackable arrangement can be implemented that can be easily adapted to various desired power classes depending on the selected number of plate-shaped elements used.

A preferred development of the above-mentioned embodiment is characterized in that the first section of at least one first plate-shaped element is joint with sealing to a second plate-shaped element arranged on the one side of the first plate-shaped element, so that the at least one first section of the reactor chamber is formed between this second plate-shaped element and the second section of the first plate-shaped element, and furthermore the second section of the first plate-shaped element is joined with sealing to a further second plate-shaped element arranged on the other side of the first plate-shaped element, so that at least one second section of the at least one reactor chamber is formed between this further second plate-shaped element and the first section of the first plate-shaped element. In this context, for the sake of completeness, it should be noted that the first section of the reactor chamber or first reactor chamber section is a reactor chamber section of a first type and the second section of the reactor chamber or second reactor chamber section is a reactor chamber section of a second type. The advantage of this preferred development consists in particular in the fact that a larger number of reactor chamber sections is created which, if required, can also be subdivided into at least two different groups.

A development of the above-mentioned preferred embodiment is further characterized in that the at least one second section of the at least one reactor chamber has at least one second channel.

At this point, for the sake of completeness, it should be noted that the first channel is a channel of a first type and the second channel is a channel of a second type.

If at least one second channel is formed in addition to the at least one first channel, the at least one second channel can preferably be thermally coupled to the at least one first channel and provided for passing through a gaseous and/or liquid heat transfer medium. Because dehydrogenation is an endothermic reaction, heat must be supplied to the reactor. In this variant, this is done by means of the at least one second channel, through which a gaseous and/or liquid heat transfer medium is passed, which, due to thermal coupling with the at least one first channel, transfers heat to the at least one first channel in order to heat the hydrogen-enriched liquid hydrogen carrier passed through the at least one first channel for dehydrogenation and/or to supply reaction enthalpy. The direction of flow through the at least one second channel should then preferably be opposite to the direction of flow through the at least one first channel, so that the flow pattern is then formed according to the countercurrent principle and a particularly good heat exchanger effect is thereby achieved. Accordingly, in this development, the reactor is used as a heat exchanger and is preferably designed in the form of a plate heat exchanger. Such use or design can be implemented particularly easily and effectively using the construction according to the invention, since it enables good thermal compression in a small space. Alternatively or additionally, it is of course also conceivable to heat the at least one first channel in a different way and/or to heat the hydrogen-enriched liquid hydrogen carrier to a first temperature before it enters the at least one first channel.

In a preferred development, several first channels and several second channels are arranged adjacent to one another in an alternating order, so that in each case a channel adjacent to a first channel is a second channel.

The at least one second plate-shaped element can be configured substantially flat.

Alternatively, it is also conceivable that the at least one second plate-shaped element includes at least one arrangement of a first section and of a second section spaced apart from the first section in a direction transverse to a plane substantially defined by the second plate-shaped element, and the first section of the second plate-shaped element is joined with sealing to the first section of the first plate-shaped element, so that the at least one first section of the reaction chamber is formed between the second section of the second plate-shaped element and the second section of the first plate-shaped element. In this alternative preferred embodiment, the at least one second plate-shaped element is provided a similar or the same structure as the at least one first plate-shaped element, so that at least one section of the reactor chamber is delimited on the one side by a protruding or raised second section in the first plate-shaped element and on the other side by a protruding or raised second section in the second plate-shaped element and is closed in the area of the edges delimiting the second sections due to the sealing connection between the first section of the first plate-shaped element and the first section of the second plate-shaped element. Accordingly, this embodiment allows reactor chamber sections in particular to be formed with a larger cross section if required.

A preferred development is characterized in that the first section of a first plate-shaped element is joined with sealing to the first section of a second plate-shaped element arranged on one side of the first plate-shaped element, so that the at least one first section of the at least one reactor chamber is formed between the second section of this second plate-shaped element and the second section of the first plate-shaped element, and furthermore the second section of the first plate-shaped element is joined with sealing to the second section of a further second plate-shaped element arranged on the other side of the first plate-shaped element, so that the at least one second section of the reactor chamber is formed between the first section of this further second plate-shaped element and the first section of the first plate-shaped element. The advantage of this preferred development consists in particular in the fact that a larger number of reactor chamber sections is produced, which can also be subdivided into at least two different groups if required.

A plurality of adjacent arrangements of a first section and a second section can preferably be provided in at least one plate-shaped element, as a result of which several adjacent and separate reactor chamber sections are formed.

Preferably, the cross section of the first and/or second section of at least one arrangement of a first section and a second section substantially has the shape of a honeycomb. In this case, a plurality of such adjacent arrangements forms a structure which is substantially honeycomb-shaped in cross-section, as a result of which particularly high rigidity and load-bearing capacity can be achieved with a low material thickness.

Alternatively or additionally, however, it is also conceivable that the cross section of the first and/or second section of at least one arrangement of a first section and a second section substantially has a corrugated shape. In this case, a plurality of such adjacent arrangements forms a cross-section that is substantially wavy or corrugated like a corrugated metal sheet, which makes it possible to achieve particularly high rigidity and load-bearing capacity with a low material thickness.

Alternatively or additionally, however, it is also conceivable that the cross section of the first and/or second section of at least one arrangement of a first section and a second section substantially has the shape of a triangle that is open at its base.

It is also alternatively or additionally conceivable that the cross section of the first and/or second section of at least one arrangement of a first section and a second section substantially has the shape of a trapezoid that is open at its base.

In the case of the two last-mentioned alternative or additional embodiments, a plurality of such adjacent arrangements forms a structure that is substantially sawtooth-shaped in cross section, which is also characterized by high rigidity and load-bearing capacity at low material thickness.

Alternatively or additionally, it is also conceivable that the cross section of the first and/or second section of at least one arrangement of a first section and a second section substantially has the shape of a rectangle that is open on one side. In this case, a plurality of such adjacent arrangements can form a structure that is substantially meandering in cross section, which is also characterized by high rigidity and load-bearing capacity at a low material thickness.

In principle, it is also conceivable to give the cross section of the first and/or second section of at least one arrangement of a first section and a second section substantially the shape of a polygon that is open on one side.

Preferably, the at least one first plate-shaped element and/or the at least one second plate-shaped element and/or the at least one first section of the reactor chamber at least partially have/has catalyst material which is designed to separate hydrogen from the hydrogen carrier as a result of a catalytic reaction and to convert the hydrogen carrier into an at least partially dehydrogenated state. In this case, at least one plate-shaped element can preferably be at least partially coated with catalyst material and/or at least one first reactor chamber section can be at least partially filled with catalyst material.

Another preferred embodiment of the invention with a reactor for dehydrogenating a hydrogen-enriched liquid hydrogen carrier, wherein the reactor has at least one hydrogen carrier inlet for the entry of the hydrogen-enriched liquid hydrogen carrier, at least one reactor chamber for at least partially separating gaseous hydrogen from the hydrogen carrier and for converting the hydrogen carrier into an at least partially dehydrogenated state, at least one hydrogen carrier outlet for release of the hydrogen carrier, which is then at least in a partially dehydrogenated state, and at least one hydrogen outlet for release of the hydrogen separated from the hydrogen carrier, is characterized in that that the at least one hydrogen outlet is closed with a semi-permeable separating element, which is designed to allow substantially only gaseous hydrogen separated from the hydrogen carrier to pass through, however, to retain the liquid hydrogen carrier and possibly other gaseous hydrocarbons. With this embodiment according to claim 19, which alternatively also represents its own and independent further aspect of the invention, the gaseous hydrogen separated from the hydrogen carrier can be separated from the liquid hydrogen carrier in a structurally simple and at the same time elegant manner. The semi-permeable separating element can preferably be designed as a semi-permeable membrane, for which purpose a suitable ceramic material and/or a suitable textile material produced corresponding to a “Goretex” membrane can be used. Alternatively, it is also conceivable to provide an arrangement of interleaved, diagonal baffle plates and a downstream filter unit made of steel wool as a semi-permeable separating element, with the interleaved, diagonal baffle plates effecting a mechanical gas-liquid separation and the filter unit made of steel wool finally ensures that the gaseous hydrogen is freed from the liquid as much as possible.

In a development of this preferred embodiment mentioned above, the at least one reactor chamber has at least one first section which is delimited by at least two plate-shaped elements, one of the plate-shaped elements having the semi-permeable separating element at least at one section or being designed as a semi-permeable separating element. Accordingly, in this development, a plate-shaped element that delimits a first reactor chamber section assumes the separating function, which is particularly advantageous if the relevant first reactor chamber section is oriented substantially horizontally and said plate-shaped element that assumes the separating function delimits the top of this reactor chamber section.

A development of this preferred embodiment mentioned above is characterized in that at least one section of the reactor chamber has at least one first channel with an inlet in fluid connection with the hydrogen carrier inlet and an outlet for passing through the hydrogen-enriched liquid hydrogen carrier and at least one second channel having an inlet and an outlet in fluid connection with the hydrogen carrier outlet for passing through the hydrogen carrier in an at least partially dehydrogenated state, the at least one first channel is oriented in such a way that its outlet is arranged above its inlet, the at least one second channel is oriented in such a way that its inlet is arranged above its outlet, and a connecting chamber is provided which is in fluid communication with the outlet of the at least one first channel, with the hydrogen outlet and with the inlet of the at least one second channel. Accordingly, in this development, the flow pattern is provided according to the countercurrent principle.

Alternatively, it is also conceivable to provide the flow pattern according to the cocurrent principle, according to which the direction of flow in the at least one first channel and in the at least one second channel have the same direction, i.e., for example, either both up, both down or both to one side.

A further preferred development is characterized in that the hydrogen outlet has a collecting chamber, the bottom of which contains at least one opening closed by the semi-permeable separating element, the connecting chamber has at least one opening on its top, and the collecting chamber with its bottom is arranged on the top of the connecting chamber in such a way that the at least one opening in the bottom of the collecting chamber is in fluid communication with the at least one opening in the top of the connecting chamber. Expediently, the bottom of the collecting chamber and the top of the connecting chamber can be more or less completely open and the collecting chamber can be arranged with its open bottom on the open top of the connecting chamber and separated from the connecting chamber by the semi-permeable separating element, wherein expediently the collecting chamber can be formed integrally with the connecting chamber.

Preferred exemplary embodiments are explained in more detail below with reference to the accompanying drawings, in which:

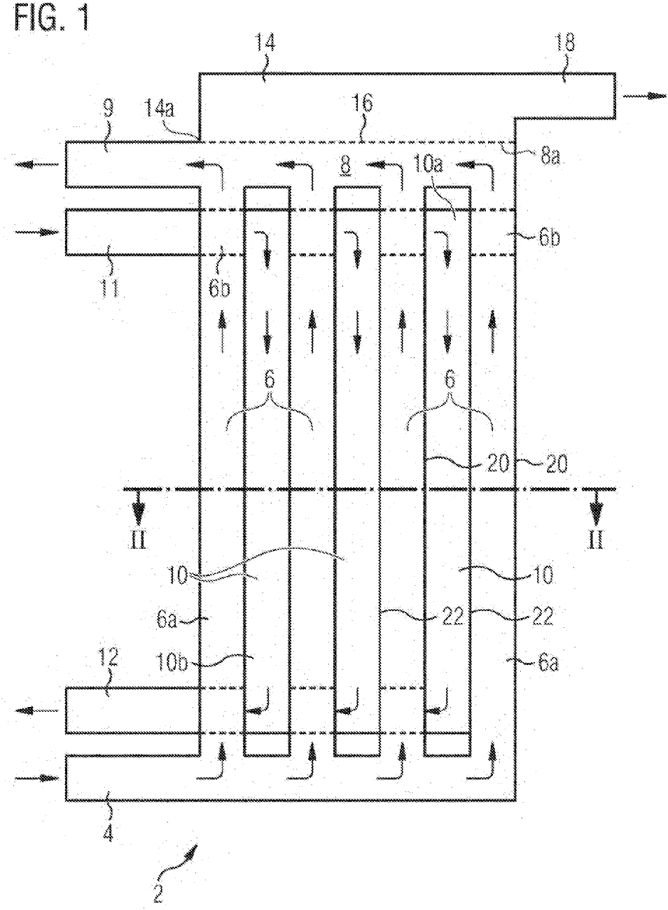

FIG. 1 shows a schematic longitudinal sectional view of a reactor according to an exemplary embodiment as part of an apparatus for dehydrogenating a liquid hydrogen carrier; and

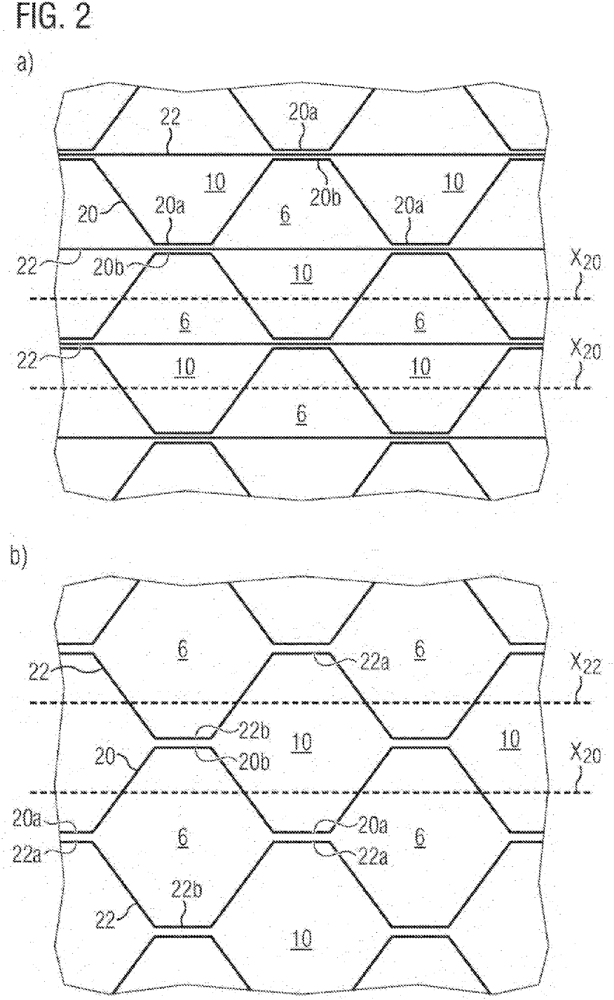

FIG. 2 shows a partial schematic cross-sectional view of a reactor chamber section formed in the reactor of FIG. 1 according to a first preferred embodiment (FIG. 2a) and a second preferred embodiment (FIG. 2b).

FIG. 1, in a schematic longitudinal sectional view from the side, shows a reactor 2 as part of an apparatus for dehydrogenating a liquid hydrogen carrier. The hydrogen carrier, which has the task of absorbing gaseous hydrogen, can be, for example, dibenzyltoluene. Alternatively, the liquid hydrogen carrier can also comprise another material that is suitable for absorbing and releasing hydrogen.

Reactor 2 has a hydrogen carrier inlet 4 through which the hydrogen-enriched liquid hydrogen carrier is fed into the reactor 2. If necessary, the hydrogen carrier can be partially or completely heated to the reaction temperature before entering hydrogen carrier inlet 4 or inside reactor 2 before entering the actual reaction chamber. As FIG. 1 also shows, reactor 2 has several first channels 6 arranged adjacent to one another, each with an inlet 6a and an outlet 6b. In the exemplary embodiment illustrated, first channels 6 are arranged substantially vertically, with their inlet 6a being provided at their lower end and their outlet 6b being provided at their upper end. Inlets 6a of first channels 6 are in fluid communication with hydrogen carrier inlet 4. The inner wall of first channels 6 is provided at least in sections with a catalyst material which is suitable for separating the hydrogen at least partially from the liquid hydrogen carrier upon contact with the hydrogen-enriched liquid hydrogen carrier; additionally or alternatively, however, it is also conceivable to at least partially introduce a fill of such a catalyst material into first channels 6. Platinum, for example, can be used as the catalyst material. The hydrogen-enriched liquid hydrogen carrier is conveyed through first channels 6 from their inlet 6a upwards to their outlet 6b, as indicated schematically by the arrows in FIG. 1. During the passage of the liquid hydrogen carrier through first channels 6, at least partial dehydrogenation of the hydrogen carrier takes place, so that the liquid hydrogen carrier, which is then in an at least partially dehydrogenated state, and the gaseous hydrogen separated from it exit separately from the upper outlets 6b of first channels 6.

As can be seen schematically in FIG. 1 also, in the exemplary embodiment shown, reactor 2 has a connecting chamber 8 on its top, which is part of the reactor head. Outlets 6b of first channels 6 open into this connecting chamber 8, so that the separated gaseous hydrogen accumulates in the upper area of connecting chamber 8 and the at least partially dehydrogenated hydrogen carrier accumulates in the lower area of the connecting chamber 8. Thus, on the one hand, connecting chamber 8 concentrates the at least partially dehydrogenated hydrogen carrier and, on the other hand, concentrates the hydrogen separated from it. Furthermore, a hydrogen carrier outlet 9 through which the at least partially dehydrogenated hydrogen carrier exits, is connected to connecting chamber 8.

In the exemplary embodiment illustrated, reactor 2 has several second channels 10, each with an inlet 10a and an outlet 10b, first and second channels 6, 10 being arranged adjacent to one another in an alternating sequence, so that in each case a channel adjacent to a first channel 6 is a second channel 10. Thus, like first channels 6, second channels 10 are also arranged substantially vertically. In the exemplary embodiment illustrated, second channels 10 are used to pass through a liquid or gaseous heat transfer medium, with the direction of flow downwards through second channels 10 and thus in the opposite direction to the first channels, in which the direction of flow is upwards, as indicated schematically by the arrows in FIG. 1. Overall, this results in a flow pattern based on the countercurrent principle, which is advantageous for a particularly effective transfer of heat from the heat transfer medium passing through second channels 10 into the heat transfer medium passing through the first channels 6. Inlets 10a formed at the upper end of second channels 10 are in fluid communication with a heat transfer medium inlet 11 in the area of the reactor head, through which the heat transfer medium enters reactor 2, which then flows downward through second channels 10. Due to the intended heat transfer from the heat transfer medium in second channels 10 into the hydrogen carrier in first channels 6, second channels 10 are thermally coupled to first channels 6 in the exemplary embodiment illustrated. Thus, the arrangement of alternately adjacent first and second channels 6, 10 forms a heat exchanger. For the dehydrogenation is an endothermic reaction that requires heat. The heat transfer medium flows through second channels 10 as a heat source. Reactor 2 also has a heat transfer medium outlet 12 which is in fluid communication with outlets 10b provided at the lower ends of second channels 10. Thus, the heat transfer medium, after giving off at least a major part of its heat, exits from lower outlets 10b of the second channels and is discharged through the heat transfer medium outlet 12 to the outside. In principle, it is of course also conceivable to provide another possibility for heating the liquid hydrogen carrier flowing through first channels 6, such as an electric heater, for example, instead of a liquid or gaseous heat transfer medium to be passed through second channels 10.

At this point, for the sake of clarity, it should be noted that, compared to the exemplary illustration in FIG. 1, reactor 2 can also contain a different and in particular higher number of channels 6, 10 and/or channels 6, 10, instead of a vertical orientation, can also be arranged in any other orientation and in particular also in a substantially horizontal orientation. If second channels 10 are not used as a heat source, they can be used to hold other suitable liquids or gases. Furthermore, if required, third channels can also be provided in reactor 2, for example. Finally, in contrast to the exemplary illustration in FIG. 1, the flow pattern can alternatively also be provided according to the cocurrent principle, so that the direction of flow in all channels 6, 10 is oriented in the same direction, in particular upwards or optionally also downward; if a gas is used as the heat transfer medium, it should flow upwards through second channels 10.

As can be seen schematically in FIG. 1 also, in the exemplary embodiment illustrated, a collecting chamber 14 is arranged with its bottom 14a on top 8a of connecting chamber 8. Top 8a of connecting chamber 8 and the bottom of collecting chamber 14 are each open, so that collecting chamber 14 is arranged with its open bottom on open top 8a of connecting chamber 8. In the exemplary embodiment illustrated, collecting chamber 14 is formed integrally or in one piece with connecting chamber 8. It is the task of collecting chamber 14 to collect the gaseous hydrogen separated from the hydrogen carrier and entering connecting chamber 8, since the gaseous hydrogen, due to its very low specific weight tends to rise further upwards in the direction of collecting chamber 14. In order to prevent liquid hydrogen carrier from getting into collecting chamber 14, collecting chamber 14 is partitioned from connecting chamber 8 by a semi-permeable separating element 16, which lets the gaseous hydrogen pass through but retains the liquid hydrogen carrier so that it stays back in connecting chamber 8. Typically, a very turbulent flow occurs in collecting chamber 14 due to a relatively large hydrogen volume, with the result that the gaseous hydrogen entrains lots of hydrogen carrier droplets. In order to prevent this phenomenon, the aforementioned semi-permeable separating element is provided. Preferably, the semi-permeable separating element 16 can be designed as a semi-permeable membrane, for which purpose preferably a suitable ceramic material and/or a suitable textile material produced corresponding to a “Goretex” membrane is used. Alternatively, it is also conceivable to form the semi-permeable separating element from an arrangement of interleaved, diagonal baffle plates and a downstream fine filter unit made of steel wool, with the interleaved, diagonal baffle plates effecting mechanical gas-liquid separation and the fine filter unit made of steel wool finally ensures maximum removal of the liquid from the gaseous hydrogen. Collecting chamber 14 has an outlet 18 through which the gaseous hydrogen collected in collecting chamber 14 is discharged from reactor 2. Thus, collecting chamber 14 and outlet 18 together form a hydrogen outlet for releasing the gaseous hydrogen separated from the hydrogen carrier.

FIG. 2 shows a partial schematic view from above of the internal structure of a section of reactor chamber 2 in cross section along a dot-dash line II-II through reactor 2 shown as an example in FIG. 1, based on a first exemplary embodiment according to FIG. 2a and a second exemplary embodiment according to FIG. 2b. As can be seen in FIG. 2 in conjunction with FIG. 1, in the exemplary embodiments illustrated, two different plate-shaped elements 20 and 22 are used for the internal construction of reactor 2, both of which are arranged adjacent to one another in an alternating sequence, so that in each case an element adjacent to a first plate-shaped element 20 is a second plate-shaped element 22, and thus the first and second plate-shaped elements 20, 22 alternate in their order in the view of FIG. 2 from bottom to top and from top to bottom. In this way, a stackable arrangement can be implemented that can be easily adapted to various desired power classes for reactor 2 depending on the selected number of plate-shaped elements 20, 22 used.

In accordance with the two exemplary embodiments illustrated in FIGS. 2a and 2b, first plate-shaped element 20 is provided with a honeycomb structure in cross section. This structure is formed in that the first plate-shaped element 20 has a plurality of first sections 20a and second sections 20b, which are arranged adjacent to one another in an alternating sequence, so that a section adjacent to a first section 20a is a second section 20b. As can also be seen in FIGS. 2a and 2b, second sections 20b are offset in height compared to first sections 20a, namely in a direction transverse to a plane substantially defined by the first plate-shaped element 20, which defines a so-called virtual main axis, which, in the exemplary embodiment illustrated, forms approximately the central axis between the first and second sections 20a, 20b, which are offset from one another, as indicated by a dashed line X₂₀. While in FIG. 2 the first plate-shaped element 20 is in a substantially straight plane, as can also be seen from the straight course of dashed line X₂₀, plate-shaped element 20 can alternatively also assume a curved shape, so that first plate-shaped element 20 is in a correspondingly curved plane. Thus, in a bottom-up view of FIG. 2, second section 20b forms a raised section relative to first section 20a, or in the reverse direction, in a top-down view of FIG. 2, first section 20a forms a raised section relative to second section 20b. Since the first and second sections 20a, 20b, which are arranged offset relative to one another, are incorporated into first plate-shaped element 20 and first plate-shaped element 20 extends continuously over its length and width, first and second sections 20a, 20b are connected to one another, as shown in FIG. 2 also. Thus, in first plate-shaped element 20, a plurality of adjacent arrangements, each consisting of a first section 20a and a second section 20b, line up adjacent to one another.

In the exemplary embodiment illustrated in FIG. 2a, the second plate-shaped element 22 forms a substantially flat plate. As can also be seen in FIG. 2a and a first plate-shaped element 20 rests with its first sections 20a on an adjacent second plate-shaped element 20 in each case, with a sealing or sealed connection between first sections 20a of a first plate-shaped element 20 and an adjacent second plate-shaped element 22, which can be established for example by gluing, soldering or welding or by using sealing elements. Thus, a second section 20b is delimited on both sides by an edge, which is at the same time a part of a first section 20a sealingly or sealed connected to the second plate-shaped element 22. As a result, a cavity is enclosed by a second section 20b of first plate-shaped element 20 and the opposite section of second plate-shaped element 22, which cavity forms a chamber section of reactor 2, which, in the exemplary embodiment illustrated, is a first channel of reactor 2 shown in FIG. 1. As further indicated in FIG. 2a, several groups are side by side or one above the other, each group thereof comprising a first plate-shaped element 20 and a second plate-shaped element 22 which is sealingly or sealed connected thereto in the manner described above. In this case, a first plate-shaped element 22 is arranged with its first sections 20a at the adjacent second plate-shaped element 22 located on the one side of first plate-shaped element 20, while on the other opposite side of the first plate-shaped element there is another adjacent second plate-shaped element Element 22 is arranged, with which second sections 20b of first plate-shaped element 20 are then sealingly or sealed connected. This creates further cavities, each of which is enclosed by a first section 20a of a first plate-shaped element 20 and an opposite section of a second plate-shaped element 22 and which form further reactor chamber sections, which, in the exemplary embodiment illustrated, are second channels 10 of reactor 2 depicted in FIG. 1. Due to the structure described above, first and second channels 6, 10 in the first exemplary embodiment according to FIG. 2a each have a substantially trapezoidal cross section. The structure described above can be preferably produced by mechanical forming such as, for example, forming under compressive conditions first plate-shaped elements 20, which originally consisted of a flat plate.

Alternatively, it is also conceivable to provide first plate-shaped element 20 with such a sawtooth-shaped structure, so that first and second channels 6, 10 assume a substantially triangular or otherwise polygonal cross-section. Furthermore, alternatively, it is also conceivable to provide first and second sections 20a, 20b of first plate-shaped elements 20 with the shape of a rectangle that is open at its bottom, so that first plate-shaped element 20 is provided with a substantially meandering structure in cross section. Furthermore, alternatively, it is also conceivable to provide first and second sections 20a, 20b of first plate-shaped elements 20 with a corrugated shape, so that first plate-shaped element 20 is provided with a structure substantially corrugated in cross section.

The same applies in principle to the exemplary embodiment illustrated in FIG. 2b. However, the second exemplary embodiment according to FIG. 2b differs from the first exemplary embodiment according to FIG. 2a in that second plate-shaped elements 22 have the same or at least a similar cross-sectional shape as first plate-shaped elements 20 and therefore also have a sawtooth-shaped structure or similar in the exemplary embodiment illustrated. Thus, in the second exemplary embodiment according to FIG. 2b, second plate-shaped elements 22 are also provided with first and second sections 22a, 22b, which are offset in height relative to one another, specifically in the direction transverse to a plane defined by second plate-shaped elements 22, which is indicated in FIG. 2b as a dashed line X₂₂. With regard to further details on the cross-sectional shape and structure of second plate-shaped elements 22, which substantially correspond to the cross-sectional shape and structure of first plate-shaped elements 20, reference is made to the description of the first exemplary embodiment previously provided with reference to FIG. 2a in order to avoid repetition. As in the first exemplary embodiment according to FIG. 2a, also in the second embodiment according to FIG. 2b, first and second plate-shaped elements 20 and 22 are in alternating order adjacent to one another or one above the other in the view of FIG. 2b, being in contact with one another with their first sections 20a, 22a and their second sections 20b, 22b in each case to produce a sealing or sealed connection. Thus, a second section 20b of a first plate-shaped element 20 and a second section 22b of an adjacent second plate-shaped element 22 are each delimited on both sides by an edge which, at the same time, is also part of an adjacent first section 20a of first plate-shaped element 20 or a first section 22a of second plate-shaped element 22, the first and second plate-shaped elements 20, 22 being sealing or sealed connected to one another at their first sections 20a, 20b. In the same way, a first section 20a of a first plate-shaped element 20 and a first section 22a of an adjacent second plate-shaped element 22 are each delimited on both sides by an edge which is also part of an adjacent second section 20b of first plate-shaped element 20 or 22b of the second plate-shaped element 22, first and second plate-shaped elements 20, 22 being sealing or sealed connected to one another in the area of their second sections 20b, 22b. As a result, first cavities are created, each of which is enclosed by a second section 20b of a first plate-shaped element 20 and an opposite second section 22b of an adjacent second plate-shaped element 22. These first cavities form first reactor chamber sections, which in the exemplary embodiment illustrated are first channels 6 of reactor 2 depicted as an example in FIG. 1. Furthermore, in the second exemplary embodiment according to FIG. 2b, there are second cavities, each of which is enclosed by a first section 20a of a first plate-shaped element 20 and an opposite first section 22b of an adjacent plate-shaped element 22 and which form second reactor chamber sections which are, in the exemplary embodiment depicted, second channels 10 of reactor 2 depicted in FIG. 1 as an example. Because of the special structure described above, first and second channels 6, 10 in the second exemplary embodiment according to FIG. 2b each have a substantially honeycomb cross section.

At least one of first and second plate-shaped elements 20, 22 preferably has catalyst material, at least in sections, at least on the inner wall delimiting first channels 6, which catalyst material is designed to separate hydrogen from the hydrogen carrier due to a catalytic reaction and convert the hydrogen carrier into at least a partially dehydrogenated state. As already mentioned above, alternatively or additionally, it is also conceivable to at least partially introduce a fill of such a catalyst material into first channels 6.

At this point, it should be noted that, in contrast to the exemplary embodiment illustrated in FIG. 1, for example, first channels 6 in the area of their outlet end can each be provided with a first outlet for releasing the at least partially dehydrogenated hydrogen carrier and a second outlet for releasing the gaseous hydrogen separated from the hydrogen carrier, in each case the second outlet communicating with outlet 18 for releasing the hydrogen, but is closed with its own semi-permeable separating element, which takes on the same task as semi-permeable separating element 16 provided in the exemplary embodiment according to FIG. 1

Finally, it should also be noted that alternatively at least one of the first and second plate-shaped elements 20, 22 can also be provided with the above-mentioned semi-permeable separating element at least in one section or even be designed as a semi-permeable separating element. Thus, in this variant, one of the plate-shaped elements 20, 22 assumes the separating function, which is particularly advantageous if at least said plate-shaped element is oriented substantially horizontally and delimits the associated channel at its top. Due to the integration of the separating function in one of the plate-shaped elements 20, 22, the use of a separate semi-permeable separating element is unnecessary in this variant. Conversely, it is fundamentally also conceivable to design the semi-permeable separating element 16 depicted in FIG. 1 in the manner of a first or second plate-shaped element 20, 22. With a horizontal orientation and alignment of the channels, the hydrogen must be discharged via each first channel through a semi-permeable separating element (corresponding to the semi-permeable separating element 16 illustrated as an example in FIG. 1), so that in this case a corresponding number of chambers must be provided that perform the same task as the collecting chamber 14 depicted in FIG. 1 and are connected to one another in the area of the outlet 18.

1. An apparatus comprising a reactor for dehydrogenating a hydrogen-enriched liquid hydrogen carrier, wherein the reactor comprises at least one hydrogen carrier inlet for the entry of the hydrogen-enriched liquid hydrogen carrier, at least one reactor chamber for at least partial separation of gaseous hydrogen from the hydrogen carrier and for conversion of the hydrogen carrier into an at least partially dehydrogenated state, at least one hydrogen carrier outlet for outputting the hydrogen carrier which is in an at least partially dehydrogenated state, at least one hydrogen outlet for outputting the hydrogen dissolved from the hydrogen carrier, at least one first plate-shaped element and at least one second plate-shaped element, wherein at least one portion of the at least one reactor chamber is disposed between the first plate-shaped element and the second plate-shaped element, wherein the at least one first plate-shaped element includes at least one arrangement of a first section and of a second section spaced apart from the first section in a direction transverse to a plane substantially defined by the first plate-shaped element, and the first section of the first plate-shaped element is joined with sealing to the at least one second plate-shaped element so that a first portion of the reaction chamber is formed between the second section of the first plate-shaped element and the second plate-shaped element.

2. The apparatus according to claim 1, wherein at least one first portion of the at least one reactor chamber has at least one first channel.

3. The apparatus according to claim 1, wherein several first plate-shaped elements and several second plate-shaped elements are arranged adjacent to one another in an alternating sequence, so that in each case an element adjacent to a first plate-shaped element is a second plate-shaped element.

4. The apparatus according to claim 3, wherein the first section of at least one first plate-shaped element is joined with sealing to a second plate-shaped element arranged on the one side of the first plate-shaped element, so that the at least one first portion of the reactor chamber is formed between this second plate-shaped element and the second section of the first plate-shaped element, and furthermore the second section of the first plate-shaped element is joined with sealing to a further second plate-shaped element arranged on the other side of the first plate-shaped element, so that at least one second portion of the at least one reactor chamber is formed between this further second plate-shaped element and the first section of the first plate-shaped element.

5. The apparatus according to claim 4, wherein the at least one second portion of the at least one reactor chamber has at least one second channel thermally coupled to an adjacent first channel.

6. The apparatus according to claim 5, wherein several first channels and several second channels are arranged adjacent to one another in an alternating sequence, so that in each case a channel adjacent to a first channel is a second channel.

7. The apparatus according to claim 1, wherein the at least one second plate-shaped element is substantially flat.

8. The apparatus according to claim 1, wherein the at least one second plate-shaped element includes at least one arrangement of a first section and of a second section spaced apart from the first section in a direction transverse to a plane substantially defined by the second plate-shaped element, and the first section of the second plate-shaped element is joined with sealing to the first section of the first plate-shaped element so that the at least one first portion of the reaction chamber is formed between the second section of the second plate-shaped element and the second section of the first plate-shaped element.

9. The apparatus according to claim 4, wherein the first section of a first plate-shaped element is joined with sealing to the first section of a second plate-shaped element arranged on the one side of the first plate-shaped element, so that the at least one first portion of the at least one reactor chamber is formed between the second section of this second plate-shaped element and the second section of the first plate-shaped element, and furthermore the second section of the first plate-shaped element is joined with sealing to the second section of a further second plate-shaped element arranged on the other side of the first plate-shaped element, so that the at least one second portion of the reactor chamber is formed between the first section of this further second plate-shaped element and the first section of the first plate-shaped element.

10. The apparatus according to claim 1, wherein a plurality of adjacent arrangements of a first section and a second section is provided in at least one plate-shaped element.

11. The apparatus according to claim 1, wherein the cross section of the first and/or second section of at least one arrangement of a first section and a second section substantially has the shape of a honeycomb.

12. The apparatus according to claim 10, wherein a plurality of adjacent arrangements form a structure which is substantially honeycomb-shaped in cross section.

13. The apparatus according to claim 1, wherein the cross section of the first and/or of the second section of at least one arrangement of a first section and a second section substantially has the shape of a triangle that is open at its base.

14. The apparatus according to claim 1, wherein the cross section of the first and/or of the second section of at least one arrangement of a first section and a second section substantially has the shape of a trapezoid open at its base.

15. The apparatus according to claim 10, wherein a plurality of adjacent arrangements forms a structure that is substantially sawtooth-shaped in cross section.

16. The apparatus according to claim 1, wherein the cross section of the first and/or the second section of at least one arrangement of a first section and a second section substantially has the shape of a rectangle that is open on one side.

17. The apparatus according to claim 10, wherein a plurality of adj acent arrangements forms a structure that is substantially meandering in cross section.

18. The apparatus according to claim 1, wherein the at least one first plate-shaped element and/or the at least one second plate-shaped element and/or the at least one first portion of the reactor chamber at least partially have/has catalyst material which is designed to separate hydrogen from the hydrogen carrier as a result of a catalytic reaction and to convert the hydrogen carrier into an at least partially dehydrogenated state.

19. The apparatus according to claim 1 comprising a reactor for dehydrogenating a hydrogen-enriched liquid hydrogen carrier, wherein the reactor comprises at least one hydrogen carrier inlet for the entry of the hydrogen-enriched liquid hydrogen carrier, at least one reactor chamber for at least partial separation of gaseous hydrogen from the hydrogen carrier and for conversion of the hydrogen carrier into an at least partially dehydrogenated state, at least one hydrogen carrier outlet for outputting the hydrogen carrier which is in an at least partially dehydrogenated state and at least one hydrogen outlet for outputting the hydrogen separated from the hydrogen carrier, wherein the at least one hydrogen outlet is closed with a semi-permeable separating element, which is designed to allow substantially only gaseous hydrogen separated from the hydrogen carrier to pass through.

20. The apparatus according to claim 19, wherein the at least one reactor chamber has at least one first portion which is delimited by at least two plate-shaped elements and one of the plate-shaped elements has the semi-permeable separating element at least in one section or is designed as a semi-permeable separating element.

21. The apparatus according to claim 19, wherein at least one portion of the reactor chamber has at least one first channel with an inlet in fluid connection with the hydrogen carrier inlet and an outlet for passing through the hydrogen-enriched liquid hydrogen carrier and at least one second channel with an inlet and an outlet in fluid connection with the hydrogen carrier outlet for passing through the hydrogen carrier which is in an at least partially dehydrogenated state, the at least one first channel is oriented in such a way that its outlet is arranged above its inlet, the at least one second channel is oriented in such a way that its inlet is arranged above of its outlet, and a connecting chamber is provided, which is in fluid communication with the outlet of the at least one first channel, with the hydrogen outlet and with the inlet of the at least one second channel.

22. The apparatus according to claim 21, wherein the hydrogen outlet has a collecting chamber the bottom of which contains at least one opening closed by the semi-permeable membrane, the connecting chamber has at least one opening on its top, and the collecting chamber with its bottom is arranged on the top of the connecting chamber in such a way that the at least one opening in the bottom of the collecting chamber is in fluid communication with the at least one opening in the top of the connecting chamber .

23. The apparatus according to claim 22, wherein the bottom of the collecting chamber and the top of the connecting chamber are open and the collecting chamber with its open bottom is arranged on the open top of the connecting chamber and is partitioned from the connecting chamber by the semi-permeable membrane.
